(19) United States
(12) Patent Application Publication
(10) Pub. No.: US 2026/0212846 A1
(43) Pub. Date: Jul. 23, 2026

(54) INFORMATION PROCESSING APPARATUS, INFORMATION PROCESSING METHOD, AND PROGRAM

(71) Applicant: SONY GROUP CORPORATION, TOKYO (JP)

(72) Inventors: JUNICHI SHIMIZU, TOKYO (JP); KEI TAKAHASHI, TOKYO (JP); JUNICHI NAGAHARA, TOKYO (JP); MANABU FUJIKI, TOKYO (JP); IPPEI TAMBATA, TOKYO (JP); NOBUHIRO SAIJO, TOKYO (JP)

(21) Appl. No.: 19/134,835

(22) PCT Filed: Nov. 20, 2023
(86) PCT No.: PCT/JP2023/041627

§ 371 Date: Jun. 2, 2025

(30) Foreign Application Priority Data
Dec. 6, 2022 (JP) 2022-194661

(51) Int. Cl. G10H 1/00; G06T 11/10; G06V 20/58; G06V 40/10

(52) U.S. Cl. CPC G10H 1/0025; G06T 11/10; G06V 20/58; G06V 40/10; G10H 2210/111; G10H 2220/201; G10H 2220/371; G10H 2220/455

(57) ABSTRACT

The present technology relates to an information processing device, an information processing method, and a program that can provide a user with an experience in which music varies in accordance with variations in visual information. An information processing device according to the present technology recognizes an object that is present in an acquired image, and varies music in accordance with a state of the object in the image. The present technology can be applied to an information processing terminal such as a smartphone mounted on a mobile body such as an automobile.

### TECHNICAL FIELD

The present technology relates to an information processing device, an information processing method, and a program, and in particular, relates to an information processing device, an information processing method, and a program that can provide a user with an experience in which music varies in accordance with variations in visual information.

### BACKGROUND ART

There have been proposed various types of techniques of varying music, which is being played back, in accordance with the situation of a user.

PTL 1 discloses a technique of generating a parameter on the basis of information from various portions in an automobile and generating music score data on the basis of the generated parameter.

### CITATION LIST

### Patent Literature

[PTL 1]

JP 2006-69288 A

### SUMMARY

### Technical Problem

To vary music on the basis of information obtained from a vehicle body, it is conceivable to vary music by increasing the tempo in accordance with an increase in the travel speed of the automobile, or to vary the tone as the automobile travels through a curve, etc., but such variations in music tend to be monotonous. The user may be bored of monotonous variations in music.

The present technology has been made in view of such circumstances, and provides a user with an experience in which music varies in accordance with variations in visual information.

### Solution to Problem

A first aspect of the present technology provides an information processing device including: an object recognition unit that recognizes an object that is present in an acquired image; and a playback control unit that varies music in accordance with a state of the object in the image.

A second aspect of the present technology provides an information processing device including: an image analysis unit that detects pixel information at a detection position set in a frame of an image, which is being displayed; and a playback control unit that varies music in accordance with variations in the pixel information.

With the first aspect of the present technology, an object that is present in an acquired image is recognized, and music is varied in accordance with the state of the object in the image.

With the second aspect of the present technology, pixel information at a detection position set in a frame of an image, which is being displayed is detected, and music is varied in accordance with variations in the pixel information.

### BRIEF DESCRIPTION OF DRAWINGS

FIG. 1 illustrates an installation example of an information processing device according to an embodiment of the present technology.

FIG. 2 illustrates an example of object recognition.

FIG. 3 illustrates an example of music generation by a music generation application.

FIG. 4 illustrates another example of object recognition.

FIG. 5 illustrates another example of music generation by a music generation application.

FIG. 6 illustrates an image of music generation matching the position of an object.

FIG. 7 is a block diagram illustrating an example of the configuration of a user terminal.

FIG. 8 is a block diagram illustrating an example of the functional configuration of the user terminal.

FIG. 9 is a flowchart illustrating operation of the user terminal.

FIG. 10 illustrates an example of music generation that reflects the preference of a user.

FIG. 11 illustrates an example of display during music playback.

FIG. 12 illustrates detection positions for brightness information.

FIG. 13 illustrates an example of variations in display during music playback.

FIG. 14 illustrates examples of a musical scale sample.

FIG. 15 illustrates an example of music generation.

FIG. 16 is a block diagram illustrating an example of the functional configuration of the user terminal.

FIG. 17 is a flowchart illustrating operation of the user terminal.

FIG. 18 illustrates an example of a music listening environment.

FIG. 19 illustrates a video projected by a projector as enlarged.

FIG. 20 is a block diagram illustrating an example of the configuration of a music playback system.

FIG. 21 is a block diagram illustrating an example of the functional configuration of the information processing device.

FIG. 22 is a flowchart illustrating a process of generating seed data.

FIG. 23 is a flowchart illustrating a music playback process.

### DESCRIPTION OF EMBODIMENTS

Hereinafter, embodiments for implementing the present technology will be described below. The description will be made in the following order.
1. First Embodiment (Music Generation with Use of Object Information)
2. Second Embodiment (Music Generation with Use of Brightness Information)
3. Third Embodiment (Music Generation with Use of Biometric Information)
4. Others

### First Embodiment (Music Generation with Use of Object Information)

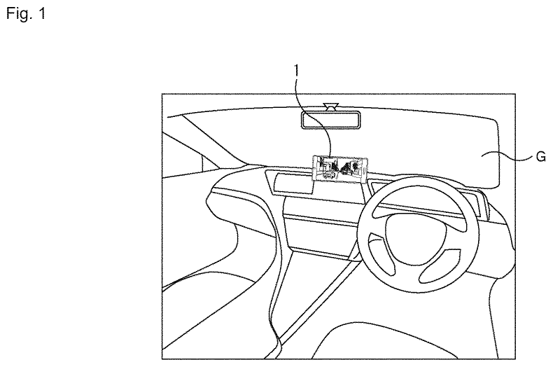

FIG. 1 illustrates an installation example of an information processing device according to an embodiment of the present technology.

As illustrated in FIG. 1, a user terminal 1 as an information processing device according to the embodiment of the present technology is installed on a dashboard of an automobile such that the back surface of a housing faces forward and the front surface of the housing faces a vehicle cabin. In the example in FIG. 1, the user terminal 1 is a smartphone. The front surface of the housing of the user terminal 1 is provided with a display constituted by an LCD or the like, and the back surface thereof is provided with a camera.

A device other than the smartphone such as a tablet terminal, a PC, or an in-vehicle terminal may be used as the information processing device.

A scene ahead captured through a windshield G is displayed in real time on the display of the user terminal 1. Thus, an application having the function to capture a scene ahead such that at least a part of the sight of a user is included in the angle of view and display the scene in real time is installed in the user terminal 1. While the dashboard of the automobile is mentioned here as the location of installation of the user terminal 1 by way of example, this is not limiting, and the user terminal 1 may be installed on side window glass or rear window glass, for example.

The application prepared in the user terminal 1 is also equipped with the function to generate and play back music. The music played back by the application in the user terminal 1 is output from a speaker provided in the user terminal 1 or a speaker provided in the vehicle, for example. The user as a driver can drive the vehicle while listening to music played back by the application in the user terminal 1. For example, during travel in a certain area, music linked to the area being traveled in is repeatedly played back.

Hereinafter, the application in the user terminal 1 having the function to generate and play back music will be referred to as a music generation application.

Playback of music by the music generation application is performed on the basis of a music generation parameter varied in accordance with the position on a captured image of an object recognized as being present in the image, for example. The music itself output to the user is dynamically varied in real time as the music generation parameter is dynamically varied so as to follow variations in the state of an object that is present in an image, such as the position of the object on the image.

Here, the music generation parameter is information that defines the content of constituent elements of music, such as musical scale, tone quality, rhythm, chord progression, pitch, melody, and BPM. Music including at least one of various sounds such as musical instrument sound, human voice, sound effect, natural sound, machine sound, and guidance sound is generated on the basis of the music generation parameter, for example.

The music generated on the basis of the music generation parameter includes sounds constituted by a time series of one or more parts characterized by musical scale, tone quality, rhythm, chord progression, pitch, melody, BPM, etc. One piece of music may be constituted by repetitions of the same part.

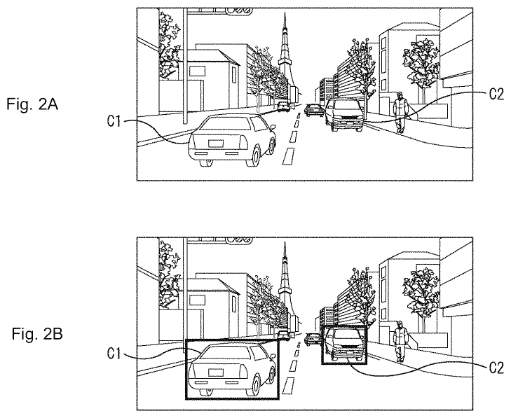

FIG. 2 illustrates an example of object recognition.

When automobiles C1, C2 are present in an image captured during travel as illustrated in A of FIG. 2, for example, the automobiles C1, C2 are recognized as being surrounded by a frame as illustrated in B of FIG. 2. In the example in FIG. 2, the automobile C1 is present at a position on the lower left of the center of the image, and the automobile C2 is present at a position slightly to the right from the center. A recognition model matching the type of object as the target to be recognized is prepared in the user terminal 1.

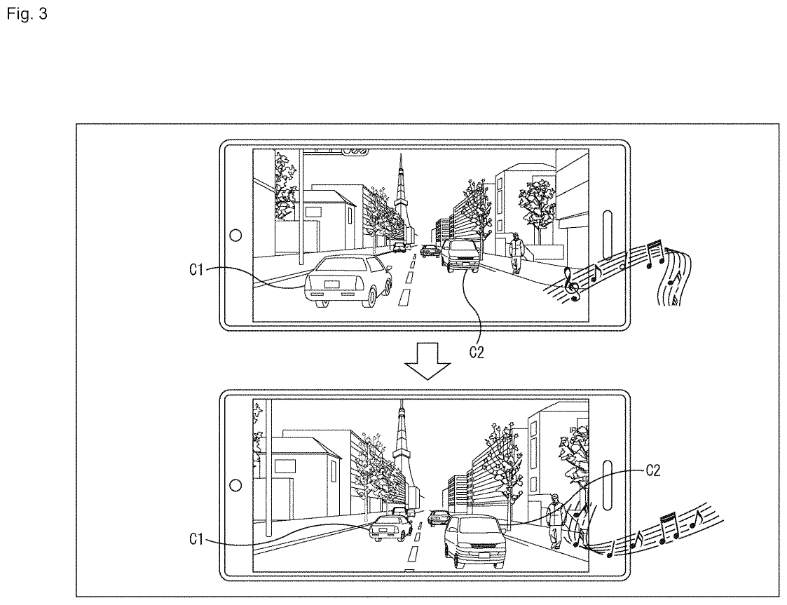

FIG. 3 illustrates an example of music generation by a music generation application.

The state of a scene illustrated in the upper part of FIG. 3 is the same as the state illustrated with reference to FIG. 2. In an image displayed on the display of the user terminal 1, the automobile C1 is present at a position on the lower left of the center of the image, and the automobile C2 is present at a position slightly to the right from the center.

In this case, a music generation parameter that indicates the musical scale of a melody, etc., is set on the basis of the respective positions of the automobile C1 and the automobile C2 recognized through object recognition, and music based on the set music generation parameter is played back. For example, when the automobile C1 and the automobile C2 are recognized during playback of music linked to the area being traveled in, a music generation parameter is set on the basis of the respective positions of the automobile C1 and the automobile C2, and playback of the music is continued with the addition of a sound matching the set music generation parameter.

When a predetermined time elapses and the positions of the automobile C1 and the automobile C2 are varied as illustrated in the lower part of FIG. 3, the music generation parameter is set (changed) on the basis of the respective positions of the automobile C1 and the automobile C2 after being varied, and music varied using the set music generation parameter is played back. The difference in the arrangement of musical notes between the upper part and the lower part of FIG. 3 indicates that different pieces of music are being played back.

Since music varies in accordance with the position of a recognized object in this manner, the user can drive while enjoying the variations in the music. Since the music generation parameter is set so as to reflect movement of the automobile that the user is driving and movement of the object, in addition, the user can enjoy the music that continues varying.

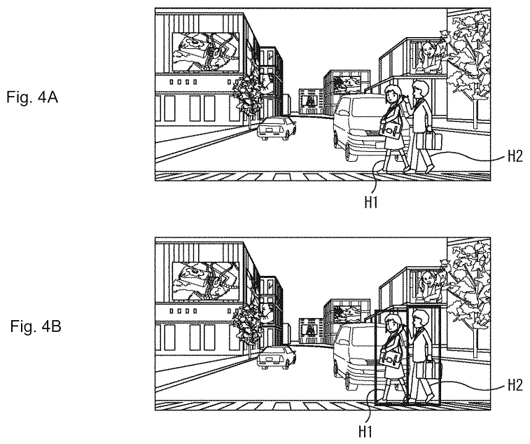

FIG. 4 illustrates another example of object recognition.

The scene illustrated in FIG. 4 is a scene captured when the automobile driven by the user approaches an intersection. When the automobile approaches an intersection, the recognition model that is used for object recognition is switched to a model for human recognition. For example, when a human H1 and a human H2 are present in a captured image as illustrated in A of FIG. 4, the human H1 and the human H2 are recognized as being surrounded by a frame in B of FIG. 4. In the example in FIG. 4, the human H1 and the human H2 are present at a position to the right from the center of the image.

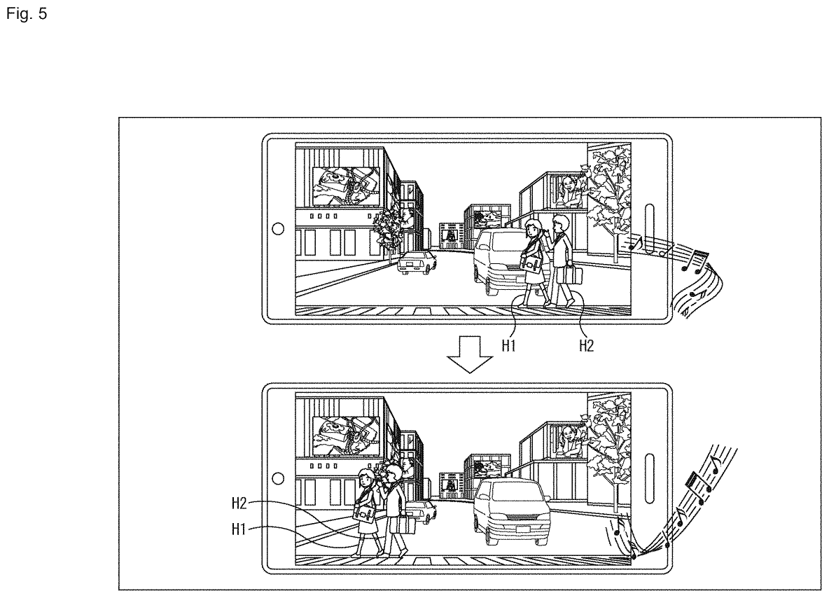

In this case, a music generation parameter is set on the basis of the respective positions of the human H1 and the human H2, and music based on the set music generation parameter is played back, as illustrated in the upper part of FIG. 5. When a predetermined time elapses and the positions of the human H1 and the human H2 are varied as illustrated in the lower part of FIG. 5, the music generation parameter is set on the basis of the respective positions of the human H1 and the human H2 after being varied, and music varied using the set music generation parameter is played back.

Although automobiles are also present in the image illustrated in FIG. 5, the automobiles are not recognized, and the music generation parameter is set on the basis of the positions of the humans as the targets to be recognized. Not only the humans but also the automobiles may be recognized, and the music generation parameter may be set on the basis of the positions of the humans and the automobiles. Objects other than the humans and the automobiles may be used as the targets to be recognized. The objects that are used as the targets to be recognized may be set in advance, or may be set or changed as appropriate on the user side. Playback control may be performed so as to vary the music generation parameter using a depth map acquired from a depth sensor or thermography, for example, besides the image captured by a capturing unit 72 as a camera.

In this manner, in the user terminal 1, the type of object to be reflected in the music generation parameter is switched in accordance with the state of movement of the user such as the travel state, such as during travel or during a halt, and the present position. For example, the type of object to be reflected in the setting of the music generation parameter is switched such that an object moving in a manner easily visually recognizable by the user is the target to be recognized. The object moving in a manner easily visually recognizable by the user during travel is an automobile, and the object moving in a manner easily visually recognizable by the user at an intersection is a human.

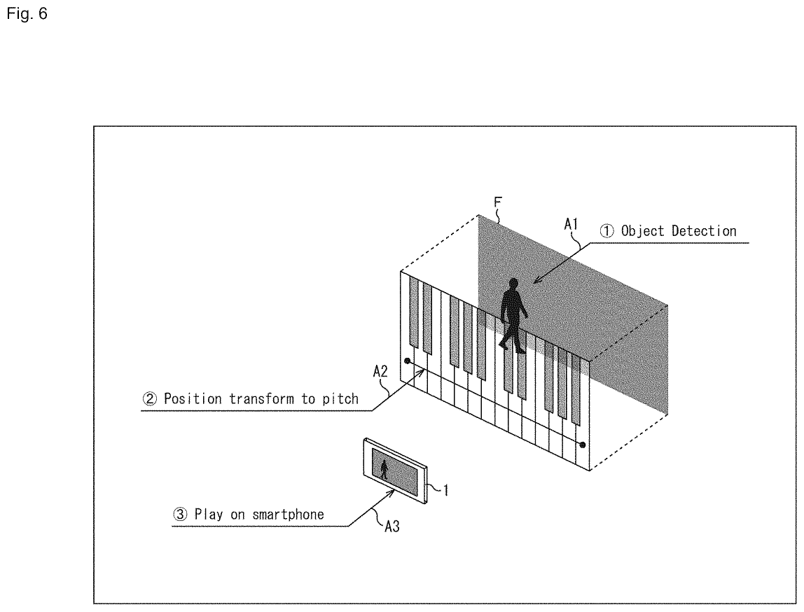

FIG. 6 illustrates an image of music generation matching the position of an object.

The image of the music generation described above is an image in which a keyboard is virtually disposed in front of a rectangle F that indicates the range of capture by the user terminal 1, and the virtually disposed keyboard is pressed in accordance with the position of an object. For example, when an object is present on the left side on the image, the music generation parameter is set so as to add a sound of a low-pitched melody to the main music. When an object is present on the right side on the image, meanwhile, the music generation parameter is set so as to add a sound of a high-pitched melody to the main music.

As the type of object as the target to be recognized is switched and music varies in accordance with movement of the object (variations in position), the user can visually understand movement of which object the variations in the music are associated with.

A music generation parameter may be linked to each type of objects, and the music generation parameter linked to a recognized object may be varied in accordance with the state of the object. For example, a music generation parameter for a rhythm is linked to automobiles as the targets to be recognized, and a music generation parameter for a melody is linked to humans. What objects are linked to what music generation parameters may be set by the user, or may be changed or set dynamically in accordance with the type of the content, etc.

### <Configuration of User Terminal 1>

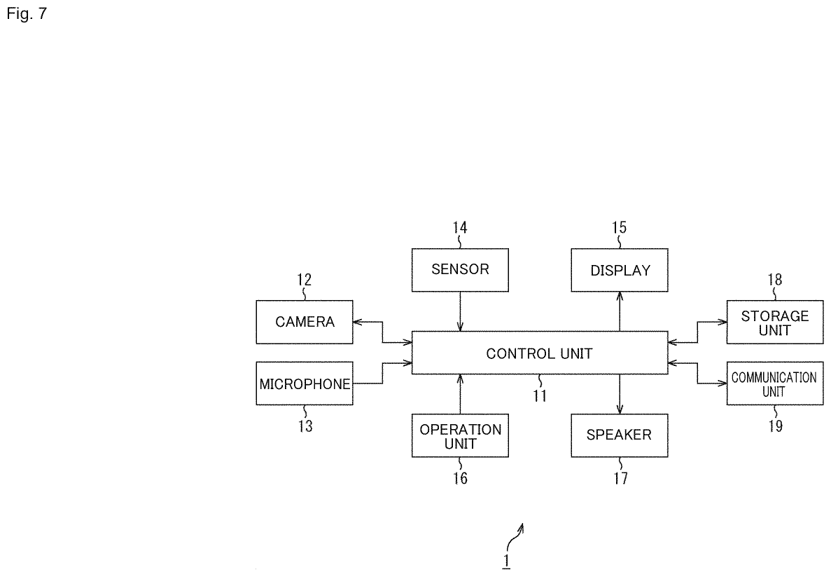

FIG. 7 is a block diagram illustrating an example of the configuration of the user terminal 1.

The user terminal 1 is constituted by connecting a camera 12, a microphone 13, a sensor 14, a display 15, an operation unit 16, a speaker 17, a storage unit 18, and a communication unit 19 to a control unit 11.

The control unit 11 is composed of a CPU, a ROM, a RAM, etc. The control unit 11 executes a predetermined program, and controls the overall operation of the user terminal 1 in response to user operations and the like.

The camera 12 is composed of a lens, an imaging element, etc. The camera 12 captures an image in accordance with control by the control unit 11, and outputs image data to the control unit 11.

The microphone 13 supplies collected voice data to the control unit 11. The user terminal 1 may be operated by voice.

The sensor 14 is constituted by various sensors such as a GPS sensor (position measurement sensor), an acceleration sensor, a gyro sensor, and a distance sensor. The sensor 14 measures the present position, speed, acceleration, etc., of the automobile driven by the user, and outputs sensor data that indicate the measurement results to the control unit 11. The control unit 11 detects a steering operation on the basis of the present position, acceleration, etc., and acquires the travel state, such as starting, stopping, turning right, and turning left, of the automobile.

The display 15 is composed of an LCD, etc. The display 15 displays various kinds of information, such as an image being captured, in accordance with control by the control unit 11.

The operation unit 16 is composed of operation buttons, a touch panel, etc., provided on a surface of the housing of the user terminal 1. The operation unit 16 outputs information that indicates the content of an operation by the user to the control unit 11.

The speaker 17 outputs a music playback sound on the basis of a signal supplied from the control unit 11.

The storage unit 18 is constituted by a flash memory or a memory card inserted into a card slot provided in the housing. The storage unit 18 stores various types of data such as image data supplied from the control unit 11.

The communication unit 19 is constituted by a wired or wireless communication module. The communication unit 19 communicates with an external device such as a server on the Internet. When music is output using a speaker mounted on the automobile, the communication unit 19 transmits music data to an in-vehicle terminal in accordance with control by the control unit 11, and causes the speaker to output a playback sound.

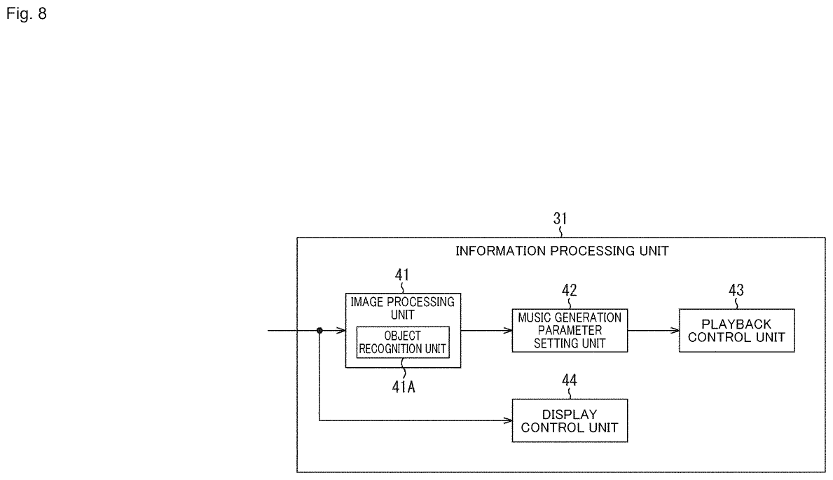

FIG. 8 is a block diagram illustrating an example of the functional configuration of the user terminal 1. At least some of the functional units illustrated in FIG. 8 are implemented by causing the control unit 11 in FIG. 7 to execute a predetermined program such as a music generation application.

As illustrated in FIG. 8, an information processing unit 31 is implemented in the user terminal 1. The information processing unit 31 is composed of an image processing unit 41, a music generation parameter setting unit 42, a playback control unit 43, and a display control unit 44. An image captured by the camera 12 is input to the image processing unit 41 and the display control unit 44. Data other than the image such as sensor data that indicate the measurement results from the sensor 14 are also input to the various units of the information processing unit 31 as appropriate.

The image processing unit 41 performs predetermined image processing on the image captured by the camera 12. An object recognition unit 41A is implemented in the image processing unit 41.

The object recognition unit 41A recognizes an object to be reflected in music generation, and outputs an object ID that indicates the type of the recognized object and position information that indicates the position of each object on the image.

An inference model (recognition model) that receives an image captured by the camera 12 as an input and that outputs an object ID and position information, for example, is prepared in the object recognition unit 41A. Recognition models for each type of object to be reflected in music generation, such as a recognition model for automobile recognition and a recognition model for human recognition, are generated in advance through machine learning, and prepared in the object recognition unit 41A. Object recognition may be performed by analyzing an image captured by the camera 12.

The music generation parameter setting unit 42 sets a music generation parameter on the basis of the object ID and the position information supplied from the object recognition unit 41A. A music generation parameter for varying a sound, such as varying the musical scale or varying the tone quality, in accordance with the position of an object is set. The music generation parameter set by the music generation parameter setting unit 42 is supplied to the playback control unit 43.

The setting of the music generation parameter by the music generation parameter setting unit 42 may be performed using an inference model generated through machine learning. In this case, an inference model that receives an object ID and position information as inputs and that outputs a music generation parameter is generated in advance through machine learning, and prepared in the music generation parameter setting unit 42.

The playback control unit 43 plays back music on the basis of the music generation parameter set by the music generation parameter setting unit 42, and causes the speaker 17, etc., to output the playback sound. Music may be played back by adding the sound based on the music generation parameter to the main music, or music may be played back by outputting only the sound based on the music generation parameter.

The display control unit 44 causes the display 15 to display the image captured by the camera 12.

### <Operation of User Terminal 1>

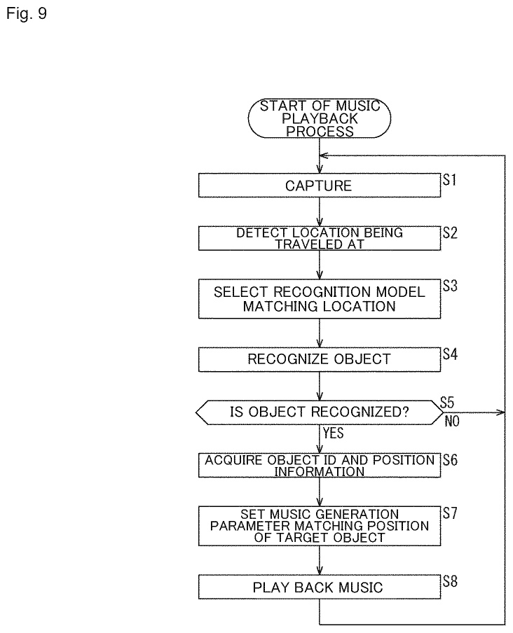

Here, operation of the user terminal 1 configured as described above will be described with reference to the flowchart in FIG. 9. The process in FIG. 9 is continued while the user is driving the automobile, for example.

In step S1, the camera 12 captures a scene ahead of the automobile. The capturing direction is not limited to the forward direction, and may be a lateral direction or the rearward direction.

In step S2, the sensor 14 detects the location being traveled at.

In step S3, the object recognition unit 41A of the image processing unit 41 selects a recognition model matching the location being traveled at. For example, a recognition model for human recognition is selected while traveling at an intersection, and a recognition model for automobile recognition is selected while traveling elsewhere.

In step S4, the object recognition unit 41A recognizes an object that is present in the captured image using the selected recognition model.

In step S5, the music generation parameter setting unit 42 determines whether or not an object is recognized by the object recognition unit 41A. When it is determined that no object is recognized, the process returns to step S1, and the above processes are repeatedly performed.

When it is determined in step S5 that an object is recognized, on the other hand, the music generation parameter setting unit 42 acquires an object ID and position information supplied from the object recognition unit 41A in step S6.

In step S7, the music generation parameter setting unit 42 sets a music generation parameter matching the position of the target object.

In step S8, the playback control unit 43 plays back music on the basis of the music generation parameter. After that, the process returns to step S1, and the above processes are repeatedly performed.

In this manner, music generation by the user terminal 1 is performed so as to vary music on the basis of object information acquired from an image such as object ID, total number of objects, and position (size, distance). Consequently, music generation that varies interactively with respect to the state of an object is achieved. In order to continue generating natural music by securing musical characteristics, it is also possible to vary only a melody without varying an accompaniment or vary a melody in accordance with the genre.

### <Modifications>

### Example of State of Object

While a music generation parameter is set so as to reflect the position of an object on an image, a music generation parameter may be set on the basis of various states of an object acquired on the basis of an image captured by the camera 12, such as a combination of the size of the object, the distance to the object, the number of objects, and the type (object ID) of the object. The state of an object that is present in an image may be acquired on the basis of information acquired by another device such as a distance sensor that constitutes the sensor 14, and reflected in a music generation parameter.

A music generation parameter may be set on the basis of the state of movement of an object, such as setting different rhythms between a case where movement of the object is fast and a case where movement of the object is slow.

A music generation parameter may be set on the basis of a combination of a plurality of states, rather than a single state such as the position of an object alone or the size of an object alone. That is, a music generation parameter can be set on the basis of at least any of a plurality of types of states of an object.

### Example of Object Recognition

While the recognition model is switched in accordance with the state of movement of the user such as the location being traveled at, the recognition model may be switched in accordance with various states of the automobile, such as the speed, acceleration, and steering state of the automobile. The user may select a recognition model for what type of object to use. The various states of the automobile such as the speed, acceleration, and steering state of the automobile are also the state of movement of the user.

Which recognition result (type of object), among recognition results from respective recognition models, is to be reflected in the music generation parameter may be switched in accordance with the state of the user, rather than switching the recognition model in accordance with the state of movement of the user. For example, at an intersection, among a recognition result for humans from a recognition model for human recognition and a recognition result for automobiles from a recognition model for automobiles, only the recognition result for humans from the recognition model for human recognition is reflected in the music generation parameter, and the recognition result for automobiles from the recognition model for automobiles is not reflected in the music generation parameter. The recognition result from which recognition model, among a plurality of recognition models, to use may be set and changed on the user side.

Example in which Preference of User is Reflected

It is difficult to keep the quality of music when it is attempted to vary the entire musical tune of the main music. The user may be allowed to select a favorite genre, artist, etc., and a music generation parameter matching the taste of the user may be generated. For example, a music generation parameter that specifies chord progression, melody, tone quality, rhythm pattern, base line, etc., that is used in musical tunes of the genre or the artist selected by the user is generated.

By continuously playing back music on the basis of the thus generated music generation parameter, it is possible to continue playing back music that matches the preference of the user and that does not bore the user.

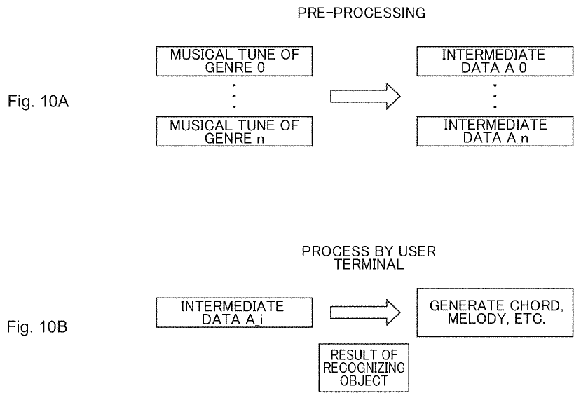

FIG. 10 illustrates an example of music generation that reflects the preference of a user.

As illustrated in A of FIG. 10, pre-processing is performed on musical tunes that constitute a DB (database) of musical tunes of a plurality of types of genres to generate intermediate data for each musical tune. The intermediate data include chords and melodies extracted from the original musical tune, for example. The intermediate data for each genre are managed in a server in the user terminal 1 or on the cloud.

During playback by the user terminal 1, a music generation parameter is set by acquiring intermediate data for a musical tune of the same genre as the genre selected by the user and varying the chord progression, melody, etc., specified by the intermediate data in accordance with the result of recognizing an object. Real-time music generation that reflects the preference of the user is implemented in this manner, for example.

### Example of Mobile Body

While a case where the user terminal 1 is installed in an automobile driven by a user and music is listened to in the automobile has been described, the music generation by the music generation application described above is also applicable to a case where music is listened to at a location other than in an automobile.

For example, the music generation by the music generation application may be performed when music is listened to during movement in a mobile body other than an automobile such as a ship, an airplane, a train, and a bicycle. Alternatively, the music generation by the music generation application may be performed when the user listens to music while walking.

### Second Embodiment (Music Generation with Use of Brightness Information)

The music generation application is equipped with the function to vary music on the basis of the brightness of an image displayed on the display 15. This function is used in a state in which the user causes the display 15 to display an image (movie) that depicts a scene, for example.

The image displayed on the display 15 may be an image captured by the camera 12, or may be an image captured by another capturing device and taken into the user terminal 1. As discussed above, an image captured by the camera of the user terminal 1 attached on the dashboard of the automobile may be used to play back music.

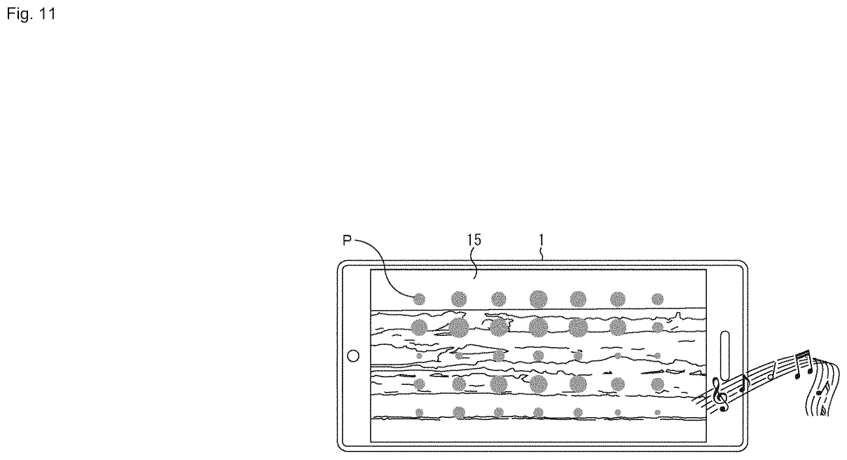

FIG. 11 illustrates an example of display on the user terminal 1 during music playback.

FIG. 11 illustrates the user terminal 1 that displays an image of a scene of a beach. The user terminal 1 performs an image analysis for each frame of the movie, and varies music that is output to the user on the basis of the detected brightness. The music is varied by varying the music generation parameter on the basis of the brightness.

The brightness of the image illustrated in FIG. 11 varies in accordance with variations in the state of waves, etc. The music being played back varies in conjunction with variations in the state of waves.

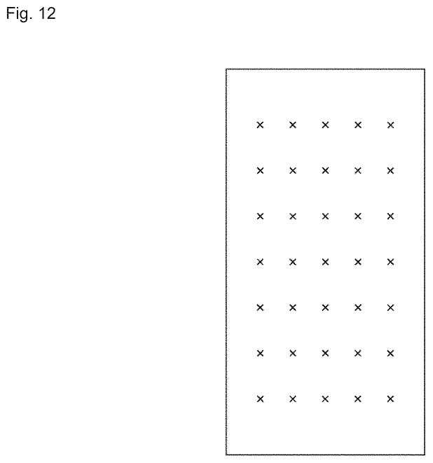

The positions of detection of the brightness are set at a plurality of locations in the frame as indicated by X-marks in FIG. 12. In the example in FIG. 12, the detection positions are set at equal intervals in an arrangement of five in the vertical direction by seven in the horizontal direction. The brightness of pixels located at the respective detection positions is detected, and music is played back on the basis of the brightness of the respective pixels, for example. The pixel as the target of detection of the brightness at each detection position may be a single pixel, or may be a plurality of pixels. The positions of detection of the brightness may be fixed, or the detection positions or the number of detection positions may be changeable on the user side. Alternatively, such positions may be varied dynamically in accordance with the type of the content.

Rendering images P in FIG. 11 displayed as superposed on the image of the scene indicate the respective detection positions. In the example in FIG. 11, light-colored circular images set to a predetermined degree of transparency are displayed as the rendering images P. The rendering images P are displayed at equal intervals in an arrangement of five in the vertical direction by seven in the horizontal direction.

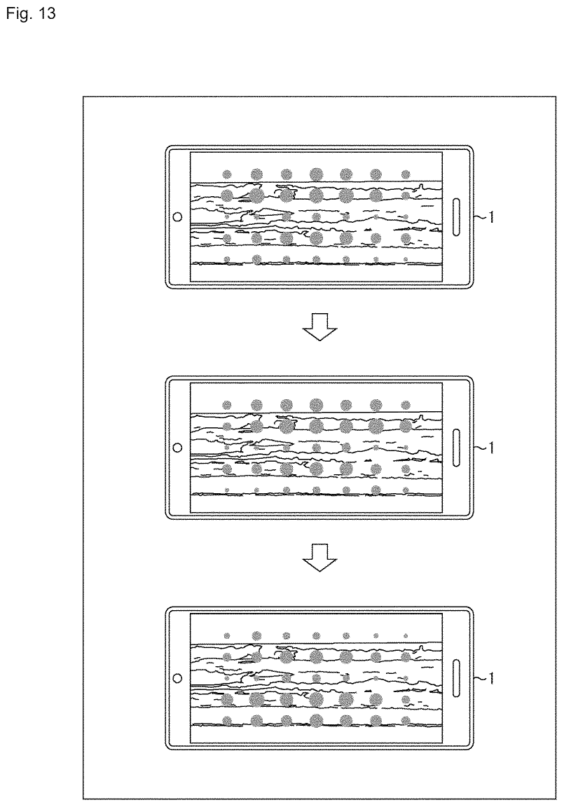

The size of the rendering images P varies in accordance with the brightness at the respective detection positions as illustrated in FIG. 13. Since the brightness at the respective detection positions varies in accordance with variations in the state of waves, the size of the rendering images P displayed at the respective detection positions varies in conjunction with variations in the state of waves.

The color of the rendering images P may vary in accordance with the brightness, or the shape of the rendering images P may vary in accordance with the brightness, rather than the size of the rendering images P varies. In this manner, it is possible to vary the state of various constituent elements of the rendering images in accordance with the brightness. The position of detection of the brightness may be set at only a single location, rather than being set at a plurality of locations.

Before the start of the music generation described above, mapping in which detection positions are set at desired positions may be performed on the basis of the result of analyzing an image, etc. In this case, the number and the locations of detection positions vary in accordance with the content of the image, etc.

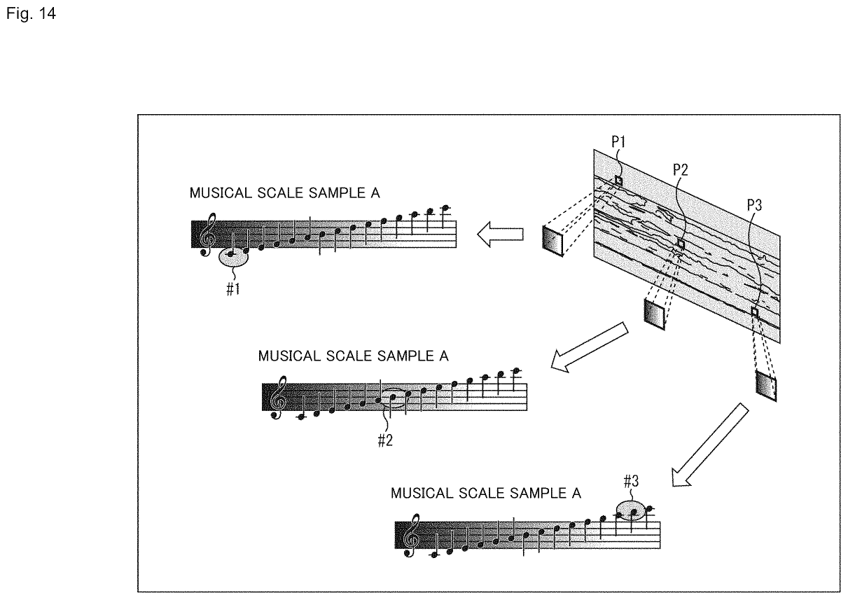

FIG. 14 illustrates an example of music generation.

FIG. 14 illustrates an example of music generation based on the brightness at respective detection positions P1 to P3 as some of the detection positions. The detection positions P1 to P3 are detection positions set at the upper left, the center, and the lower right, respectively, on the image.

As indicated by the heads of the white arrows in FIG. 14, a musical scale sample A as music of a predetermined length is set for each detection position. The music generation parameter that specifies which sound in the musical scale playback starts at varies in accordance with the brightness, for example. In the example in FIG. 14, it is specified that playback starts at a sound indicated by an ellipse #1 in accordance with the brightness at the detection position P1, and it is specified that playback starts at a sound indicated by an ellipse #2 in accordance with the brightness at the detection position P2. In addition, it is specified that playback starts at a sound indicated by an ellipse #3 in accordance with the brightness at the detection position P3.

The sounds of the musical scale samples A played back from the sounds specified by the respective music generation parameters are combined and output. The image of the music generation described above is an image in which musical instruments are virtually disposed at the detection positions on the image and sounds are output from the plurality of virtually disposed musical instruments.

Different pieces of music may be set to the detection positions, rather than the same music is set thereto.

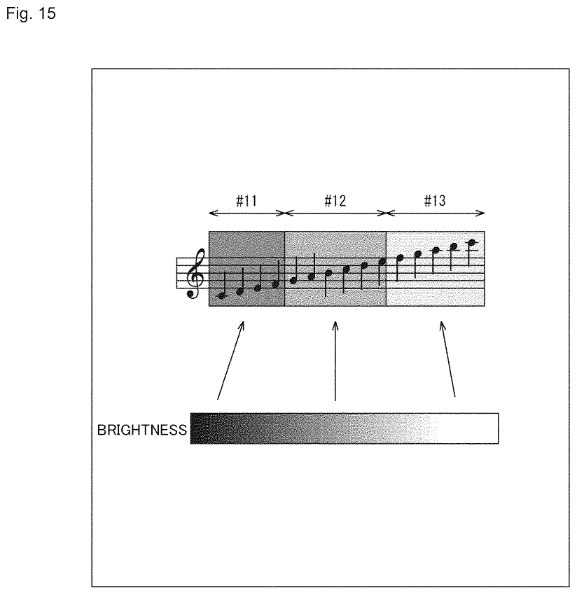

FIG. 15 illustrates examples of a musical scale sample.

In the example in FIG. 15, it is determined at random which sound in the musical scale, among the musical scale sample set to each detection position, playback starts at. For example, playback starts at any sound in the musical scale in the lower register indicated by a bidirectional arrow #11 at a detection position with low brightness, and playback starts at any sound in the musical scale in the middle register indicated by an arrow #12 at a detection position with higher brightness. In addition, playback starts at any sound in the musical scale in the upper register indicated by an arrow #13 at a detection position with high brightness.

In this manner, it is possible to determine at random the sound at which playback starts on the basis of the brightness, even when the same music is set to the detection positions.

Playback of music set to the detection positions may be started at the same timing, or may be started at different timings. When playback of music set to the detection positions is started at the same timing, the playback timing is determined in accordance with the beat or the bar, for example. When playback of music set to the detection positions is started at different timings, meanwhile, playback is started instantaneously at the timing when the brightness varies to a certain degree, for example.

### <Configuration of User Terminal 1>

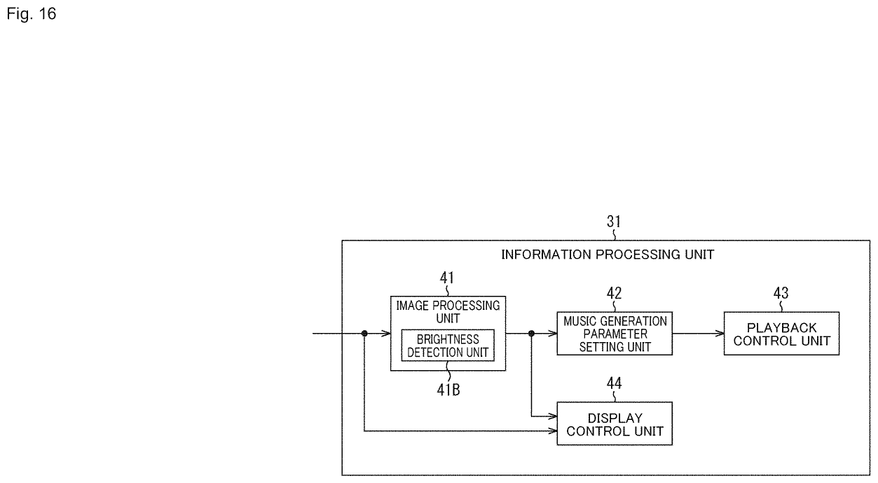

FIG. 16 is a block diagram illustrating another example of the functional configuration of the user terminal 1.

Among the components illustrated in FIG. 16, the same components as the components described with reference to FIG. 8 are given the same reference signs. Redundant description will be omitted as appropriate. The information processing unit 31 in FIG. 16 is also implemented by causing the control unit 11 in FIG. 7 to execute a predetermined program such as a music generation application.

The configuration of the information processing unit 31 illustrated in FIG. 16 is different from the configuration illustrated in FIG. 8 mainly in that a brightness detection unit 41B is provided in place of the object recognition unit 41A.

The brightness detection unit 41B detects the brightness at the detection positions by analyzing an image captured by the camera 12. Information that indicates the brightness at the detection positions detected by the brightness detection unit 41B is supplied to the music generation parameter setting unit 42 and the display control unit 44.

The music generation parameter setting unit 42 sets a music generation parameter to be used to play back music set to the detection positions on the basis of the brightness, and outputs the music generation parameter to the playback control unit 43. The musical scale, rhythm, code progression, timing to start playback, etc., are specified by the music generation parameter set by the music generation parameter setting unit 42. For example, the music generation parameter is set for each detection position.

The playback control unit 43 plays back music at the detection positions on the basis of the music generation parameter set by the music generation parameter setting unit 42, and causes the speaker 17, etc., to output the playback sound.

The display control unit 44 acquires an image captured by the camera 12, an image taken into the user terminal 1 from an external device, etc., and causes the display 15 to display the acquired image. In addition, the display control unit 44 displays rendering images at the detection positions, and controls display of the rendering images on the basis of the brightness detected by the brightness detection unit 41B.

### <Operation of User Terminal 1>

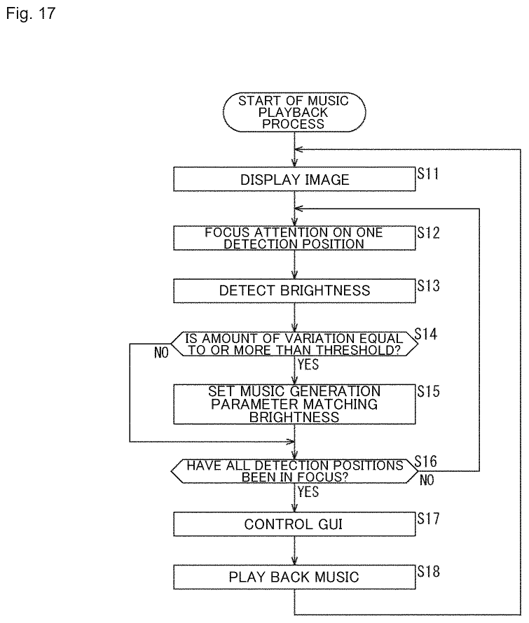

Here, operation of the user terminal 1 to vary music in accordance with brightness will be described with reference to the flowchart in FIG. 17.

In step S11, the display control unit 44 causes the display 15 to display an image that depicts a scene, etc.

In step S12, the brightness detection unit 41B focuses attention on one detection position.

In step S13, the brightness detection unit 41B detects the brightness at the detection position in focus.

In step S14, the music generation parameter setting unit 42 determines whether or not the amount of variation in the brightness at the detection position is equal to or more than a threshold.

When it is determined that the amount of variation in the brightness at the detection position is equal to or more than the threshold, the music generation parameter setting unit 42 sets a music generation parameter matching the brightness in step S15. When it is determined in step S14 that the amount of variation in the brightness at the detection position is not equal to or more than the threshold, the process in step S15 is skipped.

In step S16, the brightness detection unit 41B determines whether or not all the detection positions have been in focus. When it is determined in step S16 that there is any detection position that has not been in focus yet, the process returns to step S12, and the processes discussed above are repeatedly executed.

When it is determined in step S16 that all the detection positions have been in focus, the display control unit 44 controls a GUI (Graphical User Interface) in step S17. Consequently, the state of the rendering images displayed at the detection positions varies in accordance with the brightness at the detection positions.

In step S18, the playback control unit 43 plays back music set at the detection positions on the basis of the music generation parameter set by the music generation parameter setting unit 42, and causes the playback sound to be output. After that, the process returns to step S11, and the above processes are repeatedly performed.

In the manner described above, the user can visually recognize variations in the melody, etc., associated with the appearance (variations in image) as the brightness at the detection positions is linked to the musical scale and music matching the brightness is played back.

### <Modifications>

Music may be generated using other pixel information acquired by analyzing an image, rather than the brightness. For example, attribute values of pixels such as hue, saturation, and lightness and various kinds of pixel information such as color and dynamic range of brightness can be reflected in variations in music.

An image as the target for analysis of pixel information may be subjected to pre-processing such as simplification. An object that is present in an image may be recognized as discussed above, and the chord progression may be varied in accordance with the recognized object.

The rendering images may be varied in color or varied temporally such that animation varies rapidly or slowly.

The display range of the entire image captured by a 360° camera may be varied on the basis of the pixel information. When the sound played back by the user terminal 1 is output as a stereo sound, the output range may be varied on the basis of the pixel information. For example, the localization of the sound can be controlled in conjunction with the recognized object or the brightness.

### Third Embodiment (Music Generation with Use of Biometric Information)

Music may be generated on the basis of information other than information acquired on the basis of an image captured by a camera. For example, music can be generated on the basis of a biological reaction of a user listening to the music.

In this example, the music varies in accordance with the biological reaction of the user. The heartbeat or the facial expression, for example, is measured as the biological reaction. Biological reactions other than the heartbeat and the facial expression, such as pulsation, body temperature, breathing rate, brain waves, and blood pressure, may be measured.

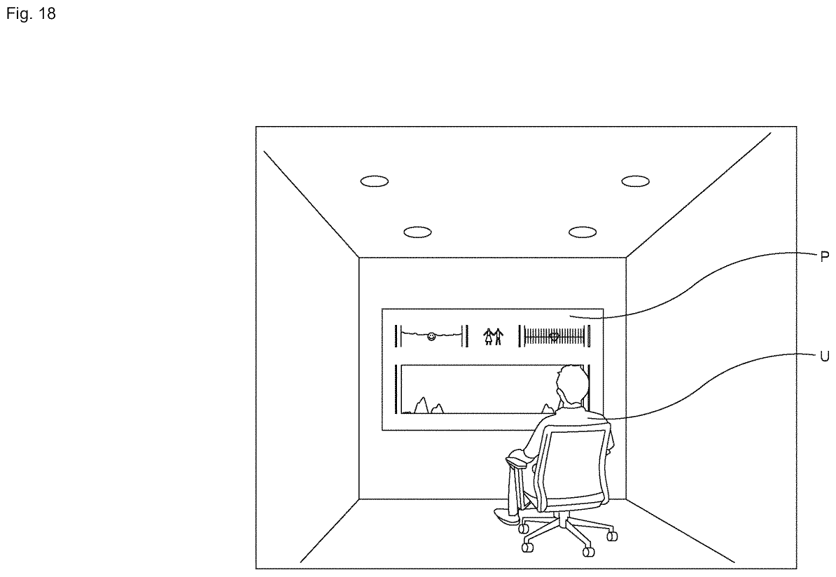

FIG. 18 illustrates an example of a music listening environment.

As illustrated in FIG. 18, music is output to a user U seated on a chair. A speaker is provided in the room illustrated in FIG. 18.

A video P is projected by a projector to a wall surface located in front of the user U. The video P and lighting in the room also vary in accordance with the biological reaction of the user U. The lightness, color temperature, etc., of a lighting device installed in the room illustrated in FIG. 18 are adjustable.

In this example, the user U can enjoy variations in music along with visually recognizable variations in the external environment such as video and lighting. The music and the external environment vary so as to induce the state of the user U to an objective state such as a relaxed state.

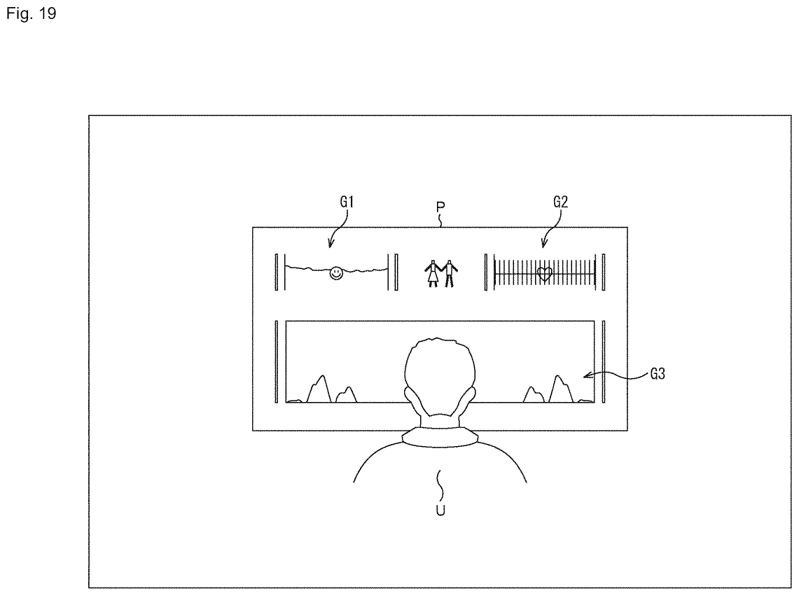

FIG. 19 illustrates the video P projected by the projector as enlarged.

As illustrated in FIG. 19, the video P including graphics G1 to G3 is projected.

The graphic G1 disposed at the upper left of the video P includes information that indicates temporal variations in the facial expression of the user U. Display of the graphic G1 varies in accordance with the measured facial expression of the user U.

The graphic G2 disposed at the upper right of the video P includes information that indicates temporal variations in the heartbeat of the user U. Display of the graphic G2 varies in accordance with the measured heartbeat of the user U.

The graphic G3 disposed on the lower side of the video P includes information that indicates temporal variations in a specific music generation parameter. The user U can visually recognize that the music generation parameter varies in conjunction with the variations in the biological reactions as a waveform displayed as the graphic G3 varies together with the graphics G1, G2. The music generation parameter may also vary on the basis of emotion (such as relaxed or tensed) of the user estimated from the biometric information, in addition to the biometric information such as pulsation, body temperature, breathing rate, brain waves, and blood pressure discussed earlier.

### <Configuration of Music Playback System>

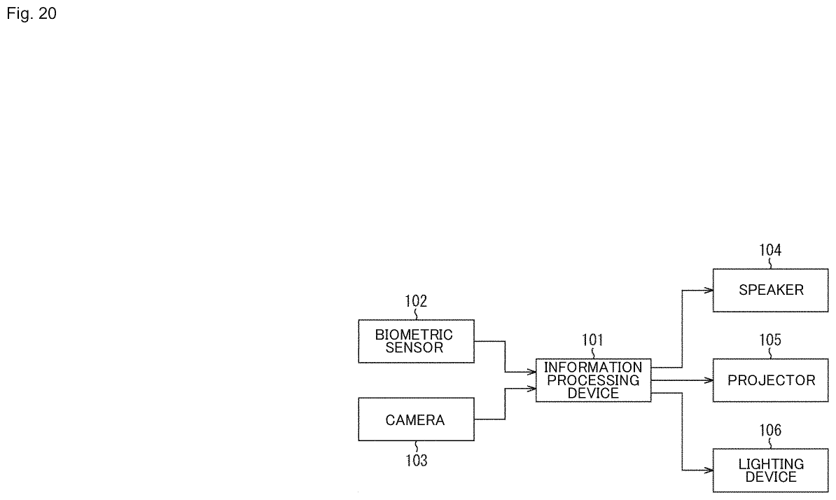

FIG. 20 is a block diagram illustrating an example of the configuration of a music playback system. The listening environment in FIG. 18 is implemented by the configuration illustrated in FIG. 20.

The music playback system is constituted by connecting a biometric sensor 102, a camera 103, a speaker 104, a projector 105, and a lighting device 106 to an information processing device 101 constituted by a computer such as a PC. The devices are connected to each other via wired or wireless communication.

The information processing device 101 detects a biological reaction of the user on the basis of sensor data that indicate the measurement results from the biometric sensor 102 and an image captured by the camera 103. The information processing device 101 varies the external environment along with varying music to be output from the speaker 104 in accordance with the biological reaction of the user.

The biometric sensor 102 is constituted by a heartbeat sensor, for example, and mounted on the body of the user listening to the music. The biometric sensor 102 outputs sensor data that indicate the result of measuring the heartbeat to the information processing device 101.

The camera 103 is installed at a predetermined position of the room such that the face of the user is included in the angle of view, for example. The camera 103 captures the user listening to the music, and outputs a captured image to the information processing device 101.

The speaker 104 outputs a playback sound of the music in accordance with control by the information processing device 101.

The projector 105 projects a video such as that described with reference to FIG. 19 in accordance with control by the information processing device 101.

The lighting device 106 is adjusted in lightness, color temperature, etc., in accordance with control by the information processing device 101.

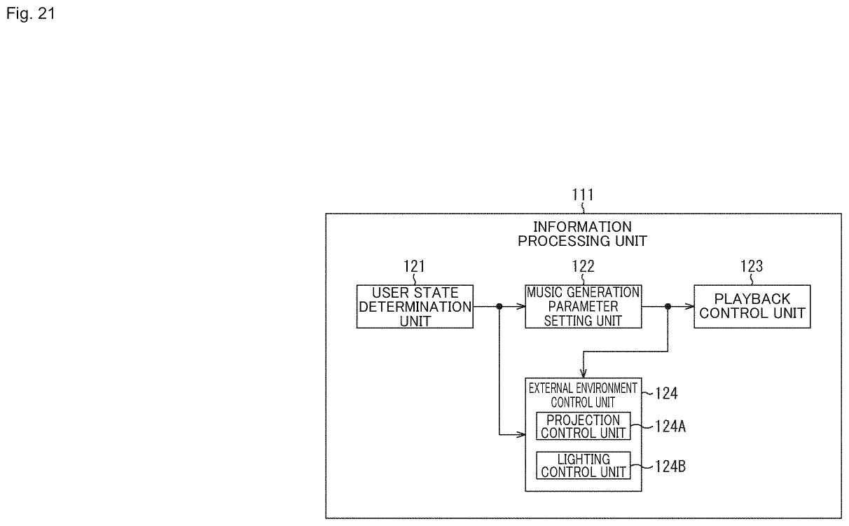

FIG. 21 is a block diagram illustrating an example of the functional configuration of the information processing device 101. At least some of the functional units illustrated in FIG. 21 are implemented when a predetermined program such as a music generation application is executed by a CPU of the information processing device 101.

As illustrated in FIG. 21, an information processing unit 111 is implemented in the information processing device 101. The information processing unit 111 is composed of a user state determination unit 121, a music generation parameter setting unit 122, a playback control unit 123, and an external environment control unit 124.

The user state determination unit 121 acquires the sensor data supplied from the biometric sensor 102 and the image supplied from the camera 103, and determines the state of the user on the basis of the acquired information.

For example, the user state determination unit 121 determines a facial expression by analyzing an image in which the face of the user is present. For example, information on the positions of characteristic points of the face, etc., is acquired as the result of determining a facial expression. The result of determining a facial expression may be acquired using an inference model generated through machine learning. In this case, an inference model for facial expression determination that receives an image as an input and that outputs information that indicates the positions of characteristic points is prepared in advance in the user state determination unit 121, for example.

In addition, the user state determination unit 121 determines whether or not the user is relaxed on the basis of the sensor data that indicate the heartbeat and the result of determining a facial expression. A value that indicates the degree of relaxation, etc., is acquired as the determination results, for example. The result of determining whether or not the user is relaxed may be acquired using an inference model generated through machine learning. In this case, an inference model for relaxed state determination that receives the sensor data that indicate the heartbeat and the result of determining a facial expression as inputs and that outputs a value that indicates the degree of relaxation is prepared in advance in the user state determination unit 121, for example.

The biometric information that includes the result of determining a facial expression, the result of determining a relaxed state, the information that indicates the heartbeat, etc., is supplied to the music generation parameter setting unit 122 and the external environment control unit 124. Information that indicates other biological reactions may be included in the biometric information and supplied to the music generation parameter setting unit 122, etc.

The music generation parameter setting unit 122 generates seed data as seeds for music generation on the basis of the heartbeat and the facial expression of the user indicated by the biometric information at the start of music playback, for example. For example, data for a specific melody with a limited number of bars are generated as the seed data.

Among the states of the user indicated by the biometric information, there exist information with large individual differences, such as the positions of characteristic points of the face, and information with small individual differences, such as the heartbeat. The degree of variation (fluctuation) is defined in accordance with the peculiarity of the biometric information, and information with great variations is used to set melody variations. Meanwhile, information with slight variations is used to set a general-purpose parameter such as tempo. In this manner, the association between the states of the user indicated by the biometric information and the types of the music generation parameter caused to reflect the states of the user is set in advance on the basis of the degree of variation, etc.

The music generation parameter setting unit 122 generates a musical tune that serves as the base of the target to be played back, for example, on the basis of the seed data. A music generation parameter that indicates the musical tune generated by the music generation parameter setting unit 122, tempo, etc., is supplied to the playback control unit 123 and the external environment control unit 124.

In addition, the music generation parameter setting unit 122 varies the music generation parameter in accordance with the biometric information supplied from the user state determination unit 121. For example, a music generation parameter that is used to play back music for inducing the user to an objective state such as a relaxed state is set by the music generation parameter setting unit 122. The music generation parameter varied by the music generation parameter setting unit 122 is also supplied, as appropriate, to the playback control unit 123, etc.

The playback control unit 123 plays back music on the basis of the music generation parameter set by the music generation parameter setting unit 122, and causes the speaker 104 to output a playback sound.

The external environment control unit 124 is composed of a projection control unit 124A that controls the projection of a video by the projector 105 and a lighting control unit 124B that controls the adjustment of lighting by the lighting device 106.

The external environment control unit 124 provides an external environment for inducing the user to an objective state by controlling the projection of a video and the adjustment of lighting on the basis of the biometric information. For example, the external environment is controlled in synchronization with variations in music represented by the music generation parameter supplied from the music generation parameter setting unit 122.

### <Operation of Information Processing Device 101>

Here, operation of the information processing device 101 configured as described above will be described.

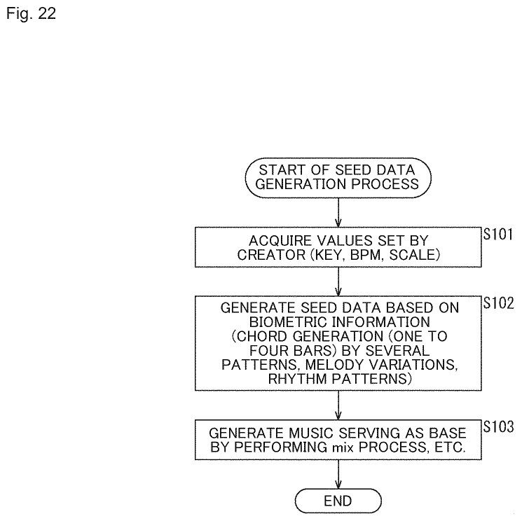

First, a process by the information processing device 101 to generate seed data will be described with reference to the flowchart in FIG. 22.

In step S101, the music generation parameter setting unit 122 acquires set values of predetermined parameters such as key, BPM, and scale. For example, these parameters which significantly affect the quality of music are set in advance by a creator, for example.

In step S102, the music generation parameter setting unit 122 generates seed data on the basis of biometric information acquired by determining a facial expression, etc. The seed data are generated by reflecting the associated biometric information in the setting of the parameters as discussed above. For example, data that indicate a chord for one to four bars in a predetermined pattern, a melody with a predetermined number of variations, and a rhythm in a predetermined pattern are generated as the seed data.

In step S103, the music generation parameter setting unit 122 generates a musical tune that serves as the base by performing a mix process of mixing the seed data and the parameters set by the creator, etc. A musical tune that serves as the base is generated by appropriately performing a process of varying the tone quality, adding a track from another sound source, etc.

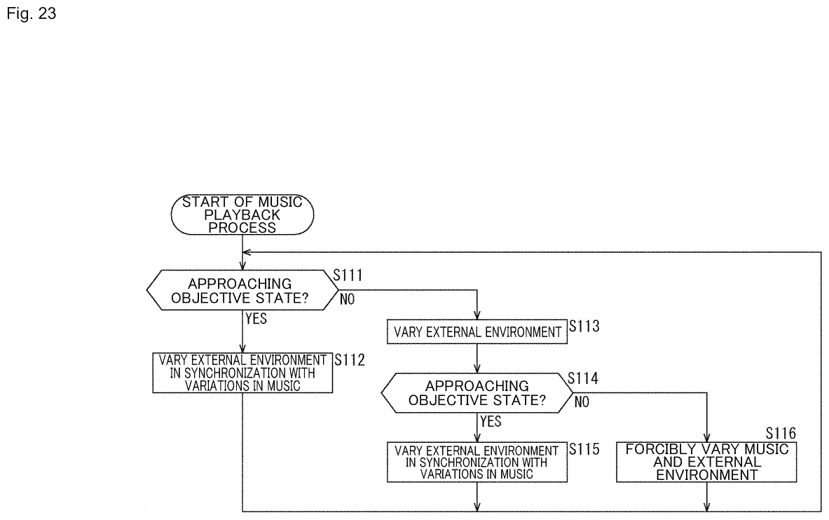

Next, a music playback process by the information processing device 101 will be described with reference to the flowchart in FIG. 23.

The process in FIG. 22 is started during playback of a musical tune that serves as the base, for example. Sensor data that indicate the heartbeat measured by the biometric sensor 102 during playback of a musical tune that serves as the base and an image captured by the camera 103 are sequentially supplied to the user state determination unit 121. The user state determination unit 121 acquires biometric information by performing various processes such as determining a facial expression on the basis of the sensor data supplied from the biometric sensor 102 and the image captured by the camera 103.

In step S111, the user state determination unit 121 determines on the basis of the biometric information whether or not the state of the user is approaching an objective state.

When it is determined in step S111 that the state of the user is approaching an objective state, a process of varying the external environment in synchronization with variations in music is performed in step S112. That is, when the music generation parameter is varied so as to gradually slow down the rhythm, the music generation parameter setting unit 122 plays back music while continuing such variations.

In addition, the projection control unit 124A synchronizes the state of the video projected by the projector 105 with variations in music by displaying information that represents variations in music such as rhythm, for example. In addition, the lighting control unit 124B synchronizes the state of the lighting with variations in music by gradually dimming the lighting in accordance with variations in music such as a slowdown of the rhythm.

When it is determined in step S111 that the state of the user is not approaching an objective state, on the other hand, the external environment control unit 124 varies the external environment in step S113.

In this case, the external environment is varied earlier than the music is varied. In a situation in which the user is to be relaxed, for example, it is desirable to vary the music to music or a melody at a slow tempo. When it is estimated on the basis of the biometric information that the user is not brought toward a relaxed state, the user is induced to a relaxed state by varying the external environment before such variations in music.

In step S114, the user state determination unit 121 determines again on the basis of the biometric information whether or not the state of the user is approaching an objective state.

When it is determined in step S114 that the state of the user is approaching an objective state, a process of varying the external environment in synchronization with variations in music is performed in step S115. Here, a process that is similar to the process in step S112 is performed by the music generation parameter setting unit 122 and the external environment control unit 124.

When it is determined in step S114 that the state of the user is not approaching an objective state, on the other hand, a process of forcibly varying music and the external environment is performed in step S116. That is, a process of rapidly varying music and the external environment, rather than gradually varying music and the external environment in accordance with variations in the state of the user, is performed.

After music, etc., is controlled in step S112, S115, S116, the process returns to step S111, and the above processes are performed repeatedly.

Since the biological reaction such as pulsation is reflected in variations in music, the user can take notice of the state of his/her own body by paying attention to the music.

By presenting variations in the biological reaction and variations in the music generation parameter using a GUI such as a video projected by the projector 105, in addition, the user can check which music parameter the biological reaction of the user himself/herself is associated with, and can enjoy variations in music more.

### <Modifications>

While the facial expression of the user is acquired as the biometric information, other information that can be acquired on the basis of an image captured by the camera 103, such as the posture of the user, may be acquired as the biometric information.

### Others

The information processing unit 31 (FIG. 8, FIG. 16) and the information processing unit 111 (FIG. 21) may be implemented in a server on the Internet, rather than being implemented in a device that is used by the user. A music generation service is provided to the user by the information processing unit 31, etc., implemented in a server on the Internet.

The series of processes discussed above can be executed by hardware, and can be executed by software. When the series of processes are executed by software, a program that constitutes the software is installed on a computer built in dedicated hardware, a general-purpose personal computer, or the like.

The installed program is provided as recorded in a removable medium constituted by an optical disc (a CD-ROM (Compact Disc-Read Only Memory), a DVD (Digital Versatile Disc), or the like), a semiconductor memory, or the like. Alternatively, the program may be provided via a wired or wireless transmission medium such as a local area network, the Internet, or digital broadcasting.

The program executed by the computer may be a program in which processes are performed chronologically in the order described herein, or may be a program in which processes are performed in parallel or at necessary timings such as when a call is made.

Herein, the term “system” refers to a collection of a plurality of constituent elements (such as devices and modules (parts)), and all the constituent elements may or may not be located within the same housing. Thus, a plurality of devices housed in separate housings and connected via a network and a single device in which a plurality of modules are housed in a single housing both constitute a system.

The effects described herein are merely exemplary and not limiting, and other effects may be obtained.

The embodiments of the present technology are not limited to the embodiments described above, and various changes can be made without departing from the gist of the present technology.

For example, the present technique may be configured as cloud computing in which a single function is cooperatively processed in a distributed manner via a network.

Additionally, each step described in the flowchart discussed above can be executed by a single device, or executed by a plurality of devices in a distributed manner.

Furthermore, when a plurality of processes is included in a single step, the plurality of processes included in the single step can be executed by a single device, or executed by a plurality of devices in a distributed manner.

### <Configuration Combination Examples>

The present technique can also have the following configurations.

(1)

An information processing device including:
an object recognition unit that recognizes an object that is present in an acquired image; and
a playback control unit that varies music in accordance with a state of the object in the image.
   (2)

The information processing device according to (1) or (2), in which
the playback control unit varies the music, with at least any of a position of the object, a number of the object, a size of the object, a type of the object, and a distance to the object being the state of the object.
   (3)

The information processing device according to (2), in which
the playback control unit varies the music so as to follow variations in the state of the object.
   (4)

The information processing device according to any one of (1) to (3), in which the object recognition unit switches, in accordance with a state of movement of a user, a type of the object as a target to be recognized.

(5)

The information processing device according to any one of (1) to (3), in which
the playback control unit switches, in accordance with a state of movement of a user, a type of the object as a target to be reflected in variations in the music.
   (6)

The information processing device according to any one of (1) to (5), in which
the playback control unit varies, in accordance with the state of the object, the music by varying a music generation parameter linked to a type of the object.
   (7)

The information processing device according to (6), in which
the playback control unit varies the music generation parameter that indicates a content of a constituent element of a musical tune selected on the basis of a preference of a user.
   (8)

An information processing method causing an information processing device to:
recognize an object that is present in an acquired image; and
vary music in accordance with a state of the object in the image.
   (9)

A program causing a computer to execute a process comprising:
recognizing an object that is present in an acquired image; and
varying music in accordance with a state of the object in the image.
   (10)

An information processing device including:
an image analysis unit that detects pixel information at a detection position set in a frame of an image, which is being displayed; and
a playback control unit that varies music in accordance with variations in the pixel information.
   (11)

The information processing device according to (10), in which
the variations in the pixel information are variations in brightness information.
   (12)

The information processing device according to (11), in which
the playback control unit varies the music by varying a music generation parameter on the basis of the pixel information.
   (13)

The information processing device according to any one of (10) to (12), in which
the image analysis unit detects the pixel information at each detection position set at a plurality of locations in the frame.
   (14)

The information processing device according to (13), in which
the playback control unit plays back music data set, in common, for each detection position in accordance with a music generation parameter matching each piece of the pixel information.
   (15)

The information processing device according to any one of (10) to (14), in which
the playback control unit varies the music in accordance with the variations in the pixel information when the variations in the pixel information are equal to or more than a threshold.
   (16)

The information processing device according to (10), in which
the playback control unit varies the music in accordance with biometric information or emotion of a user.
   (17)

The information processing device according to any of (10) to (16), further including a display control unit that displays a rendering image at the detection position, with the rendering image being in a state of varying in accordance with the variations in the pixel information.

(18)

The information processing device according to (17), in which
the display control unit varies a state of at least any of a size, a shape, and a color of the rendering image on the basis of the pixel information.
   (19)

An information processing method causing an information processing device to:
detect pixel information at a detection position set in a frame of an image, which is being displayed; and
vary music in accordance with variations in the pixel information.
   (20)

A program causing a computer to execute a process including:
detecting pixel information at a detection position set in a frame of an image, which is being displayed; and
varying music in accordance with variations in the pixel information.

### REFERENCE SIGNS LIST

1 User terminal
11 Control unit
31 Information processing unit
41 Image processing unit
41A Object recognition unit
41B Brightness detection unit
42 Music generation parameter setting unit
43 Display control unit
44 Display control unit
111 Information processing unit
121 User state determination unit
122 Music generation parameter setting unit
123 Playback control unit
124 External environment control unit
124A Projection control unit
124B Lighting control unit

1. An information processing device comprising:
an object recognition unit that recognizes an object that is present in an acquired image; and
a playback control unit that varies music in accordance with a state of the object in the image.

2. The information processing device according to claim 1, wherein
the playback control unit varies the music, with at least any of a position of the object, a number of the object, a size of the object, a type of the object, and a distance to the object being the state of the object.

3. The information processing device according to claim 2, wherein
the playback control unit varies the music so as to follow variations in the state of the object.

4. The information processing device according to claim 1, wherein
the object recognition unit switches, in accordance with a state of movement of a user, a type of the object as a target to be recognized.

5. The information processing device according to claim 1, wherein
the playback control unit switches, in accordance with a state of movement of a user, a type of the object as a target to be reflected in variations in the music.

6. The information processing device according to claim 1, wherein
the playback control unit varies, in accordance with the state of the object, the music by varying a music generation parameter linked to a type of the object.

7. The information processing device according to claim 6, wherein
the playback control unit varies the music generation parameter that indicates a content of a constituent element of a musical tune selected on the basis of a preference of a user.

8. An information processing method causing an information processing device to:
recognize an object that is present in an acquired image; and
vary music in accordance with a state of the object in the image.

9. A program causing a computer to execute a process comprising:
recognizing an object that is present in an acquired image; and
varying music in accordance with a state of the object in the image.

10. An information processing device comprising:
an image analysis unit that detects pixel information at a detection position set in a frame of an image, which is being displayed; and
a playback control unit that varies music in accordance with variations in the pixel information.

11. The information processing device according to claim 10, wherein
the variations in the pixel information are variations in brightness information.

12. The information processing device according to claim 10, wherein
the playback control unit varies the music by varying a music generation parameter on the basis of the pixel information.

13. The information processing device according to claim 10, wherein
the image analysis unit detects the pixel information at each detection position set at one or a plurality of locations in the frame.

14. The information processing device according to claim 13, wherein
the playback control unit plays back music data set, in common, for each detection position in accordance with a music generation parameter matching each piece of the pixel information.

15. The information processing device according to claim 10, wherein
the playback control unit varies the music in accordance with the variations in the pixel information when the variations in the pixel information are equal to or more than a threshold.

16. The information processing device according to claim 10, wherein
the playback control unit varies the music in accordance with biometric information or emotion of a user.

17. The information processing device according to claim 10, further comprising
a display control unit that displays a rendering image at the detection position, with the rendering image being in a state of varying in accordance with the variations in the pixel information.

18. The information processing device according to claim 17, wherein
the display control unit varies a state of at least any of a size, a shape, and a color of the rendering image on the basis of the pixel information.

19. An information processing method causing an information processing device to:
detect pixel information at a detection position set in a frame of an image, which is being displayed; and
vary music in accordance with variations in the pixel information.

20. A program causing a computer to execute a process comprising:
detecting pixel information at a detection position set in a frame of an image, which is being displayed; and
varying music in accordance with variations in the pixel information.
